(19) United States
(12) Patent Application Publication
(10) Pub. No.: US 2006/0282343 A1
(43) Pub. Date: Dec. 14, 2006

(54) Paper manufacturing system and method

(75) Inventors: Lingathural Palanisamy, Bangalore (IN); Pragathieswaran Shanmugavelu, Bangalore (IN); Sachin C. Patwardhan, Powai (IN); Madhavan P. Krishnan, Powai (IN); Mangesh D. Kapadi, Bangalore (IN); Munawar Shaik Abdul, Mumbai (IN)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/196,705

(22) Filed: Aug. 3, 2005

(30) Foreign Application Priority Data
May 5, 2005 (IN) 1145/DEL/2005

(51) Int. Cl. G06Q 10/00

(52) U.S. Cl. 705/28

(57) ABSTRACT

Paper is manufactured by receiving an order for paper, and allocating the paper order to a specific mill and allocating inventory to the order in a first linear programming optimization. Production of orders within one or more mills are sequenced using a second linear programming optimization.

### RELATED APPLICATIONS

This application claims priority to India Patent Application serial number 1145/DEL/2005 (entitled PAPER MANUFACTURING SYSTEM AND METHOD, filed May 5, 2005) which is incorporated herein by reference.

### FIELD OF THE INVENTION

The invention relates generally to manufacturing of paper, and more specifically to allocating resources in production of paper.

### BACKGROUND

The paperless society once predicted as a result of widespread computerization of information handling has not materialized, but has instead become a society where increasingly more information is generated and printed than ever. Paper products are also on the rise, such as an increase in production of paper packing products like cardboard influenced in part by consumers' ability to shop for products on the Internet, and to order from a cheapest or other preferred provider and have the ordered product packaged and shipped.

Personal computers have made it possible for nearly any person to generate a document, to retrieve a wide variety of information from the Internet, or to receive a document as part of a collaboration or communication with another party. These documents can now be just as easily printed, as inexpensive laser printers that produce very high quality output can be found for under one hundred dollars. As the ease and cost of producing documents has improved, the number of documents generate and printed has increased.

Further, subscriptions to magazines, newspapers, and other printed publications have not suffered the dramatic losses once predicted as a result of online publishing, but continue to provide strong demand to the paper producing industry. Information printed on paper can be carried, stored, and viewed with ease, and without concern for network access, power or battery availability, or the durability or portability of expensive electronics.

Production of paper therefore remains a strong industry, with a broad range of paper types and paper products produced. Some paper, such as inkjet printer paper, benefits from special coatings or certain weights, while other paper such as newsprint is intentionally of a lower grade to reduce cost. Geographic location of the paper production facility and the cost to transport paper to a customer also impact the profitability and efficiency of a paper manufacturing enterprise, as does inventory management and raw materials or inventory availability.

Careful management of these various paper manufacturing parameters is important to the profitability of paper production, particularly in competitive or low-margin environments. It is therefore desired to better manage paper manufacturing parameters across a large-scale paper manufacturing enterprise to ensure efficient operation.

### SUMMARY

In one example embodiment of the invention, paper is manufactured by receiving an order for paper, and allocating the paper order to a specific mill and allocating inventory to the order in a first linear programming optimization.

Production of orders within one or more mills is sequenced using a second linear programming optimization. In another example embodiment, paper is manufactured by receiving an order for paper, and allocating the paper order to a specific paper machine and allocating inventory to the order in a first linear programming optimization. Production of orders on one or more paper machines are sequenced using a second linear programming optimization.

### BRIEF DESCRIPTION OF THE FIGURES

FIG. 1 is a flowchart of a method of manufacturing paper, consistent with an example embodiment of the present invention.

FIG. 2 is a block diagram of data utilization in a method of managing production of paper, consistent with an example embodiment of the present invention.

FIG. 3 is a detailed flowchart of a method of producing paper products, consistent with an example embodiment of the present invention.

FIG. 4 is a block diagram of a computerized system, operable to execute machine-readable instructions for carrying out an example embodiment of the present invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Examples of the present invention presented here seek to improve the efficiency of a paper manufacturing enterprise including multiple facilities, multiple sources of inventory, or multiple paper manufacturing machines. The paper manufacturing process is managed in one example embodiment by receiving an order for paper, and allocating the paper order to a specific mill and allocating inventory to the order in a first linear programming optimization. Production of orders within one or more mills is sequenced using a second linear programming optimization.

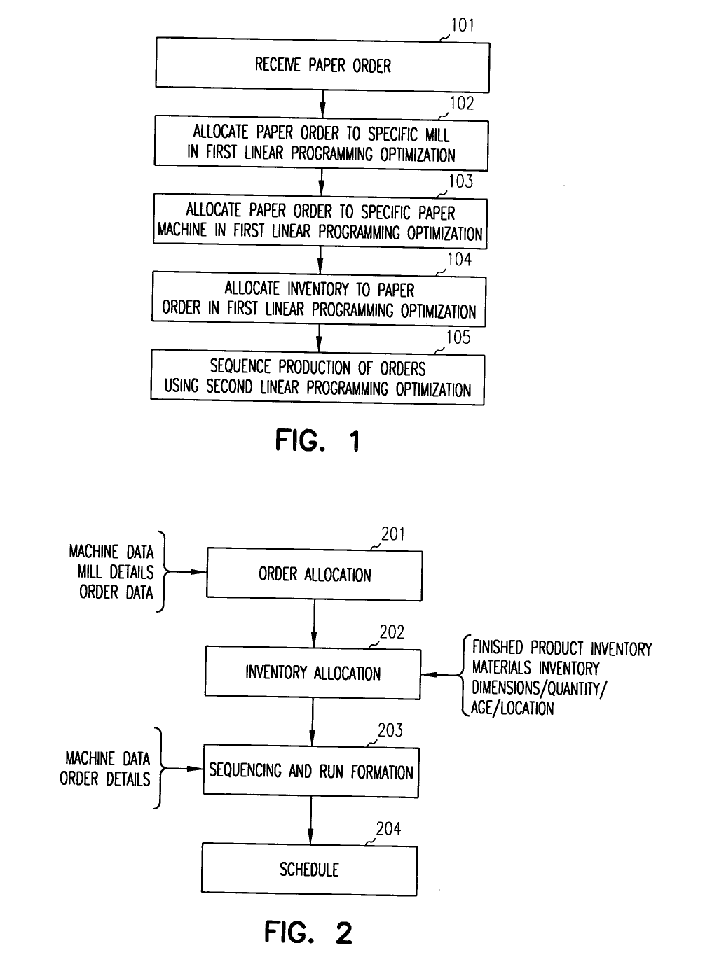

FIG. 1 shows a block diagram of a method of producing paper. At 101, a paper order is received. The paper order in one embodiment is an order for paper from a customer, and may have a priority or other identifying information associated with the order to distinguish it from orders internal to the paper producing organization to fill depleted stock of finished paper or other paper orders. At 102, the paper order is allocated to a specific paper mill, or paper manufacturing facility.

The paper order is in some embodiments more specifically allocated to a paper machine at 103, or in some embodiments assigned to multiple paper machines. Because each paper machine will vary somewhat from another paper machine, even between identical models, it is desired in some circumstances that an order not be split between paper machines to ensure uniformity of produced paper. In other embodiments, the order assignment may be split among multiple paper machines in the same manufacturing facility or in different manufacturing facilities to ease the challenge of scheduling production.

The order allocation is based in some embodiments on the capabilities of each individual machine relative to the demands imposed by the customer order. The machine must be capable of producing the desired type of paper, but it may be useful to avoid using a machine with features or capacity significantly higher than needed for a specific order. Similarly, the size of the order and the production rate of the various available paper machines are considered, as is the production capacity and availability of downstream auxiliary equipment associated with the various paper machines.

Some customers may prefer or specify a particular paper manufacturing facility or machine, such as for geographic location reasons or to ensure uniform quality of the paper purchased. Assignment of jobs or orders to each mill or machine considers the workload already assigned to a specific mill or machine, including jobs that can be assigned to other machines or mills and jobs that are to be assigned to a specific mill or paper machine.

Allocation of orders to a paper machine or paper mill is also dependent in some embodiments on the location of the machine or mill, and the transportation costs involved to provide materials to complete the order and to deliver the finished product. Availability of warehouse space is also a consideration, as is the availability and age of finished paper meeting the criteria laid forth in the order.

At 104, inventory such as finished paper, paper pulp, uncut paper rolls, or other such inventory is allocated to the paper order. The inventory allocation problem seeks to minimize inventory remaining after assignment, while also minimizing loss due to age, minimizing transportation cost, minimizing storage cost, and minimizing production cost. Available inventory in one embodiment is described by its mill location, grade or specification, dimensions, and age. These criteria are used to determine whether inventory is suitable for use to fill a given order, and whether costs and efficiency will be optimized by the allocation selected.

In some embodiments, further constraints are imposed, such as restricting allocation of a job to paper machines to machines within a single mill. This enables more efficient management of the order, and simplifies transportation costs in addition to simplifying the overall process of finding a solution to the allocation problem. Further examples of constraints that may be imposed are filling an entire order from the same grade inventory, even if different grades of available inventory would meet or exceed the order requirements, and ensuring that trim loss in producing finished paper from paper roll inventory yields acceptable trim loss. Other examples of constraints exist out of necessity, such as dictating that the dimensions of the paper in a paper order should not exceed the dimensions of a paper roll used from inventory to produce the finished product. Similarly, the expected delivery date of the finished product should be before the inventory expiry date assigned to the inventory allocated to fill an order.

The costs involved with inventory allocation are minimized by considering both production plus transport costs when allocating inventory. For example, transportation costs for the finished product may be minimized by producing finished paper at one mill rather than another, but the greatest overall cost savings may result from producing the paper at another mill to minimize inventory transportation cost. Similarly, the storage costs for inventory, both that will be used and that remains unused, should be considered to ensure profitability across a production schedule of many orders, as should the cost of inventory that may go unused and expire or be reduced in value.

The inventory allocation problem and the paper order allocation problems addressed at 102, 103, and 104 are solved in some embodiments by use of a linear programming optimization. The optimization process does not necessarily produce a single optimal solution, but in some embodiments result in multiple solutions, from which a solution that is more desirable than other solutions considered is selected. The linear programming (LP) problem is a problem in which the constraints and the desired result are all linear, and is the subject of much research. The field of operations research has applied linear programming to find solutions to problems with linear constraints, and can be adapted to solve problems such as the allocation problems of 102 and 104. A further type of linear programming, known as mixed integer linear programming (or MILP), is similar to a linear programming problem but includes at least one constraint that is not continuous but must have an integer value.

In some embodiments of the invention, a solution to the paper order and the inventory allocation problems is found in a first linear programming operation, while a solution to a sequencing linear programming problem for each paper machine or mill is solved at 105. The second linear programming operation seeks to schedule those jobs or orders assigned to a specific mill at 102 or to a specific paper machine at 103, in an order that attempts to comply with several scheduling constraints.

While it may at first seem desirable to manufacture as much paper as possible as quickly as can be done, this results in a warehousing cost for the finished product before it can be shipped on the desired date. On-time delivery is important to make the customer happy, so delivery time and other constraints are considered in sequencing orders assigned to specific mills or machines. Similarly, the cost of delivery may vary, such that transportation cost can be reduced by using a cheaper transportation provider or method if a longer delivery time can be tolerated.

Changing a machine from producing one type of product to another type of paper product involves at least some degree of cost, and possibly a significant cost if significant changes are made. Sequence-dependent product changeover costs are desirably minimized in sequencing order production. In addition, costs related to paper waste in trimming bulk or roll paper to finished paper are incurred, and are desirably minimized.

Production of the paper in some embodiments is subject to a minimum run length requirement, either on a machine-by-machine or mill-by-mill basis. The current status of the paper machine, including maintenance status and setup status for the previous run are considered, along with any priority that might be assigned to a particular order. For example, an order may be assigned a priority from one to five, where orders of five have the highest priority and are not permitted to be delivered late, while a priority of three may have some tolerance in delivery timing, and an order with a priority of one is a noncritical order to fill depleted finished paper inventory.

One example embodiment of a linear programming optimization operation to solve the scheduling problem will present multiple solutions, showing the tradeoffs that must be made between the various competing objectives and constraints discussed above, such as warehouse cost, transportation cost, late delivery cost, trim loss, paper machine grade change cost, and other such costs. The operator can then select a schedule that is deemed most desirable, while gaining an understanding of the tradeoffs necessary in planning a production schedule given a certain pool of jobs.

Some embodiments will schedule orders on a rolling horizon, meaning orders are added to the existing schedule on a regular basis. For example, speculative orders may be placed into the schedule, and converted to firm orders as the scheduled date of production draws closer. Large orders that are far away in time can similarly be scheduled as firm or speculative orders, irrespective of the time horizon for firm scheduling. Such a system can also be used to predict the capacity or availability of a paper mill or machine over a time horizon longer than the firm order scheduling horizon, helping plan capacity, maintenance, and recovery from unforeseen breakdowns or other such problems in the scheduling process.

In one moving or rolling horizon example, the firm orders are set only for a short time horizon, such as 10 to 15 days. After linear programming solutions are found for the short-term scheduling problem, the entire problem is solved over the long-term horizon of two to three months, considering the constraints and factors such as maintenance, large orders, and other such criteria.

FIG. 2 is a diagram illustrating data employed in various operations in an example embodiment of the invention. At 201, the order allocation operation uses data such as machine data, mill details, and order data to determine the proper mill or machine allocation for a particular order. This data is in some embodiments retrieved from a database or other information handling system, such as retrieving order details from an order sales system and retrieving machine and mill details from a database. Similarly, the inventory allocation at 202 relies upon finished inventory data, unfinished materials inventory such as uncut paper inventory, and inventory specifications such as age, dimensions, quantity, and location.

The sequencing and run formation at 203 uses machine data or mill data, as well as order details and other information to sequence the paper machine or production route within the mill. The result of the sequencing operation and the constraints imposed on the scheduling operation is the schedule or schedules produced at 204, as were described in greater detail in conjunction with FIG. 1.

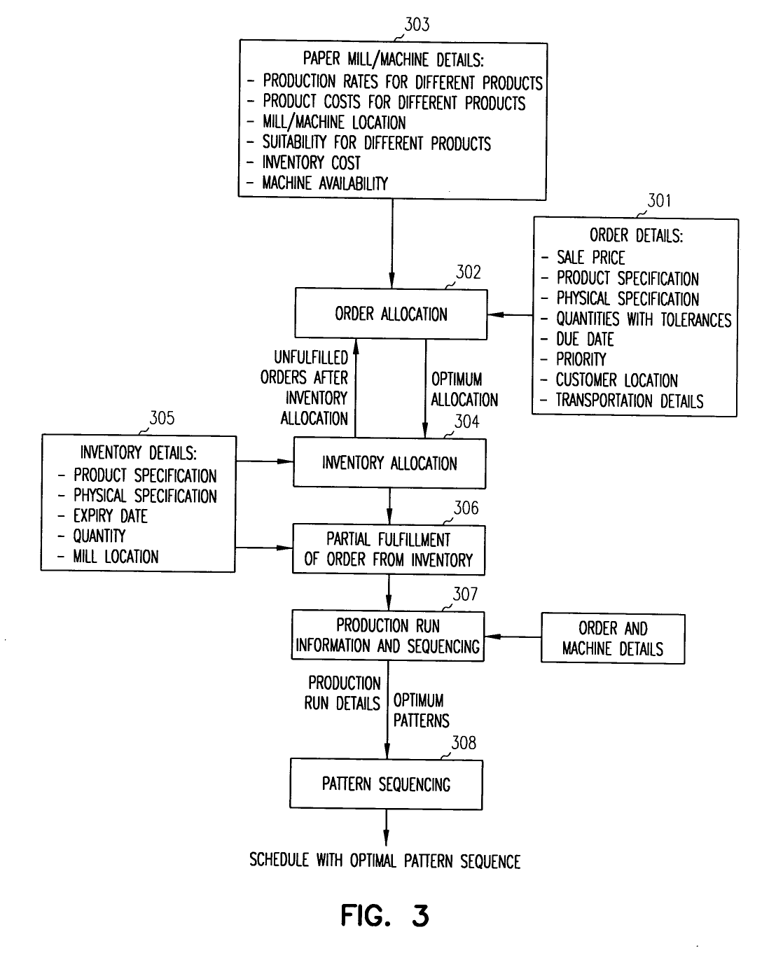

FIG. 3 shows a block diagram illustrating a more detailed method of producing paper products, consistent with an example embodiment of the present invention. Order details are collected at 301, including sale price, product specifications, physical specifications, quantity, tolerances, due date, order priority, customer location, and other transportation details. This order information is provided to an order allocation operation at 302, and solutions are found using linear programming such as a mixed integer linear programming optimization routine. The order allocation process also utilized paper machine or paper mill details as are shown at 303, such as production rates for various products for the paper machines or mills, production costs for different products, machine location, machine parameters or configurability to determine suitability for producing a particular product, machine and inventory availability, and storage and transportation costs associated with a particular machine or mill location.

Inventory allocation is performed at 304. This involves solving another linear programming problem, and the solutions in some embodiments are related to the solutions to the order allocation problem solved at 302 and so are solved in the same linear programming optimization, such as via the same computer program. The inventory allocation at 304 is performed using inventory details as shown at 305, including use of product specifications, physical specifications, expiration date information, quantity, and mill location data for the inventory. Once the inventory allocation is done, order allocation is revisited at 302 to ensure that the inventory location or other inventory factors are considered in allocating the order to a paper machine or paper mill. In alternate embodiments, order allocation and inventory allocation problems are solved concurrently in the same linear programming operation

At 306, inventory left from the inventory allocation is assigned to fill suitable pending orders, either in whole or partially, or is stored as finished product inventory to be used to fill other orders. Orders are sequenced on individual paper machines or within individual paper mills at 307, such as by using the 10-15 day firm schedule horizon discussed in conjunction with previous examples. Trim loss in cutting paper rolls or bulk paper down to finished paper is also determined at 307, and is selected in some embodiments along with derivation of an optimum or desirable pattern determined to have minimal or low paper trim loss. The cutting patterns are sequenced for individual production runs on each paper machine at 308, at which point the paper production schedule is largely complete.

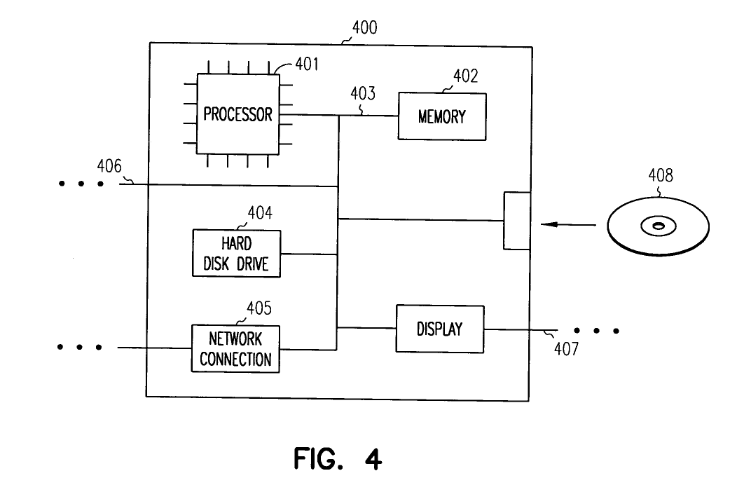

FIG. 4 illustrates an example computerized system upon which the invention may be practiced, and a machine-readable medium consistent with an example embodiment of the present invention. The computerized system 400 has a processor 401 and memory 402 linked by bus 403. The bus also links nonvolatile storage such as a hard disk drive 404, from which machine-readable instructions and other data are loaded into memory for the processor's use. A network connection 405 couples the computerized system to a network of other computerized systems, such as a database, an order entry system, or the Internet. Computer users can provide input to the computer via peripheral devices such as a mouse or a keyboard coupled to the computer through a user interface 406, and receive feedback via a display or monitor coupled through display adapter connection 407. A machine readable medium such as compact disc read-only memory (CD-ROM) 408 stores software executable on the computerized system, and is loaded or installed onto the hard disk drive 404 or other nonvolatile storage from which it is loaded into memory for execution. The instructions stored on the machine-readable compact disc 408, machine-readable hard disk drive 404, and machine-readable memory 402 are executed by the processor 401 to perform certain functions, such as to perform the linear programming operations or other elements of the paper manufacturing process as described herein.

The examples presented here illustrate how paper manufacturing can be planned and scheduled using multiple linear programming operations. The systems and methods presented here enable production of paper to be more efficient, more predictable, and to better utilize those resources available to the paper production operation. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A method of manufacturing paper, comprising:
receiving an order for paper;
allocating the paper order to at least one specific mill and allocating inventory to the order in a first linear programming optimization; and
sequencing production of orders within at least the specific mill using a second linear programming optimization.

2. The method of manufacturing paper of claim 1, wherein receiving an order for paper comprises receiving at least one of a customer identification, paper grade, paper size, paper finish, paper weight, paper color, and delivery date.

3. The method of manufacturing paper of claim 1, wherein the allocation of the paper order to a specific mill further comprises allocating the paper order to a specific machine within the specific mill.

4. The method of manufacturing paper of claim 1, wherein sequencing production of paper orders within one or more mills further comprises sequencing production of paper orders within one or more machines within the one or more paper mills.

5. The method of manufacturing paper of claim 1, wherein inventory comprises at least one of uncut paper rolls, finished paper products, and paper pulp.

6. The method of manufacturing paper of claim 1, wherein the inventory allocation is based on at least one of availability of inventory, age of inventory, cost to transport the inventory, trim loss incurred were the inventory to be used, and production cost change if the inventory is not used.

7. The method of manufacturing paper of claim 1, wherein allocation of the paper order to a specific mill is based on at least one of transportation cost, mill capacity, mill availability, mill backlog, warehouse availability, paper machine availability, and order criteria.

8. The method of manufacturing paper of claim 1, wherein at least one of the first and the second linear programming optimizations are solved using a mixed integer linear programming optimization.

9. A method of manufacturing paper, comprising:
receiving an order for paper;
allocating the paper order to a specific paper machine and allocating inventory to the order in a first linear programming optimization; and
sequencing production of orders within one or more paper machines using a second linear programming optimization.

10. The method of manufacturing paper of claim 9, wherein receiving an order for paper comprises receiving at least one of a customer identification, paper grade, paper size, paper finish, paper weight, paper color, and delivery date.

11. The method of manufacturing paper of claim 9, wherein inventory comprises at least one of uncut paper rolls, finished paper products, and paper pulp.

12. The method of manufacturing paper of claim 9, wherein the inventory allocation is based on at least one of availability of inventory, age of inventory, cost to transport the inventory, trim loss incurred were the inventory to be used, and production cost change if the inventory is not used.

13. The method of manufacturing paper of claim 9, wherein allocation of the paper order to a specific machine is based on at least one of transport cost, machine capacity, machine availability, machine backlog, warehouse availability, and order criteria.

14. The method of manufacturing paper of claim 9, wherein at least one of the first and the second linear programming optimizations are solved using a mixed integer linear programming optimization.

15. A machine-readable medium with instructions stored thereon, the instructions when executed operable to cause a computerized system to:
receive an order for paper;
allocate the paper order to a specific mill and allocate inventory to the order in a first linear programming optimization; and
sequence production of orders within one or more mills using a second linear programming optimization.

16. The machine-readable medium of claim 15, wherein receiving an order for paper comprises receiving at least one of a customer identification, paper grade, paper size, paper finish, paper weight, paper color, and delivery date.

17. The machine-readable medium of claim 15, wherein the allocation of the paper order to a specific mill further comprises allocating the paper order to a specific machine within the specific mill.

18. The machine-readable medium of claim 15, wherein sequencing production of paper orders within one or more mills further comprises sequencing production of paper orders within one or more machines within the one or more paper mills.

19. The machine-readable medium of claim 15, wherein inventory comprises at least one of uncut paper rolls, finished paper products, and paper pulp.

20. The machine-readable medium of claim 15, wherein the inventory allocation is based on at least one of availability of inventory, age of inventory, cost to transport the inventory, trim loss incurred were the inventory to be used, and production cost change if the inventory is not used.

21. The machine-readable medium of claim 15, wherein allocation of the paper order to a specific mill is based on at least one of transport cost, mill capacity, mill backlog, warehouse availability, and order criteria.

22. The machine-readable medium of claim 15, wherein at least one of the first and the second linear programming optimizations are solved using a mixed integer linear programming optimization.

23. A machine-readable medium with instructions stored thereon, the instructions when executed operable to cause a computerized system to:
receive an order for paper;
allocate the paper order to a specific paper machine and allocate inventory to the order in a first linear programming optimization; and
sequence production of orders within one or more paper machines using a second linear programming optimization.

24. The machine-readable medium of claim 23, wherein receiving an order for paper comprises receiving at least one of a customer identification, paper grade, paper size, paper finish, paper weight, paper color, and delivery date.

25. The machine-readable medium of claim 23, wherein inventory comprises at least one of uncut paper rolls, finished paper products, and paper pulp.

26. The machine-readable medium of claim 23, wherein the inventory allocation is based on at least one of availability of inventory, age of inventory, cost to transport the inventory, trim loss incurred were the inventory to be used, and production cost change if the inventory is not used.

27. The machine-readable medium of claim 23, wherein allocation of the paper order to a specific mill is based on at least one of transport cost, mill capacity, mill backlog, warehouse availability, and order criteria.

28. The machine-readable medium of claim 23, wherein at least one of the first and the second linear programming optimizations are solved using a mixed integer linear programming optimization.

29. A method for planning and scheduling of paper manufacturing, comprising:
receiving an order for paper;
allocating the paper order to a specific paper mill and allocating inventory to the order in a first linear programming optimization; and
sequencing production of orders within one or more production routes within the paper mill using a second linear programming optimization.
